(19) United States
(12) Patent Application Publication
(10) Pub. No.: US 2005/0282722 A1
(43) Pub. Date: Dec. 22, 2005

(54) Two part cleaning composition

(76) Inventors: Kent B. McReynolds, Racine, WI (US); Elias H. Shaer, San Antonio, TX (US)

Correspondence Address: S.C. JOHNSON & SON, INC., 1525 HOWE STREET, RACINE, WI, 53403-2236, US

(21) Appl. No.: 10/869,748

(22) Filed: Jun. 16, 2004

(51) Int. Cl. C11D 3/00

(52) U.S. Cl. 510/302

(57) ABSTRACT

A two part cleaning composition, apparatus and method of use is described. One part of the cleaning composition contains an oxidizing agent. The two part cleaning composition provides for shelf stability during storage by controlling the pH solution at a different level in each of the first part and the second part of the composition. At a point of use of the cleaning composition, the first part and the second part are combined resulting in an automatic adjustment of the pH level through admixture of the first part and the second part to provide a pH level for the combined composition to achieve optimum cleaning of a surface with the composition. One part of the cleaning composition is maintained at a pH of from about 4 to about 5 and a second part of the composition is maintained at a pH of greater than 10. The pH of the combined composition at the point of use is from 7 to 12, preferably from about 8 to about 11. Surfaces suitable for treatment by the cleaning composition include hard surfaces, e.g. bathroom and kitchen surfaces, and soft surfaces, e.g. carpet.

### FIELD OF INVENTION

The present invention is directed generally to a cleaning composition containing an oxidizing agent, as well as to an apparatus for storing and dispensing the cleaning composition and a method of cleaning with the cleaning composition. The cleaning composition is maintained in two parts during storage with the two parts being combined for treatment of a hard surface or soft surface. One part of the composition has a pH of about 4 to about 5 during storage and one part of the composition has a pH of at least 10 during storage. Upon combination of the two parts, the composition resulting from the combination has a pH of from 7 to 12. The pH levels of the two parts provide for storage stability, while the adjusted pH upon combination of the two parts provides for optimum cleaning performance.

### BACKGROUND OF THE INVENTION

Liquid cleaning compositions which include an oxidizing agent for cleaning a surface, conventionally require a pH greater than 12.5 in order to provide shelf stability to the composition during storage. However, while providing the composition with shelf stability, a high composition pH also slows down the cleaning action of the oxidizing agent during treatment of a surface, such as for mold/mildew stain removal. At a high pH, mold/mildew stain removal will take approximately 5 to 10 minutes to occur during treatment as compared to being essentially instantaneous when the pH of the oxidizing agent is 10. However, when the overall composition is maintained during non-use at a pH of 10, the stability of the composition degrades making the composition unstable for long term storage. Thus, currently commercial mold/mildew stain remover products have a composition pH of greater than 12.5 to provide for storage stability.

Attempts have been made to provide for a lower pH in a bleach surface cleaning composition, e.g. U.S. Pat. No. 5,767,055 wherein the cleaning composition is maintained during storage in two separate compartments with the oxidizing agent maintained separate from the cleaning components thereby allowing for a pH above about 11 to 11.5 and more preferably at about 12 or above. In use, the high pH remains present for the admixture. Due to the higher pH, the amounts of additives necessary to overcome the solutions alkalinity is higher than desired in order to achieve the desired cleaning efficacy. This results in a higher cost for the product.

Accordingly, it would be desirable to provide for shelf stability of cleaning compositions containing an oxidizing agent while at the same time providing for minimization of the amount of additives necessary to overcome a bleach solution's alkalinity while also decreasing the amount of oxidizing agent necessary without decreasing the cleaning efficiency of the composition or the shelf stability of the cleaning composition.

### OBJECTS AND SUMMARY OF THE INVENTION

Therefore, an object of the present invention is to provide for a shelf or storage stable cleaning composition containing an oxidizing agent wherein the cleaning composition has both a pH suitable for long term shelf stability and a pH suitable for providing instantaneous mold/mildew stain removal upon treatment of a surface.

A further object of the present invention is to provide a cleaning composition which is shelf stable and provides for cleaning efficiency while utilizing a minimized amount of oxidizing agent and cleaning additives.

The objects of the present invention are achieved by providing a cleaning composition present in two parts. The two parts are maintained separate in storage and combined for treatment of a surface. A first part includes at least one surfactant when an oxidizing agent is not present in the first part and optionally includes at least one surfactant when an oxidizing agent is present, at least one pH adjusting agent present in an amount to provide a pH of from about 4 to about 5 to the first part, and water. A second part includes at least one surfactant when an oxidizing agent is not present in the second part and optionally includes at least one surfactant when an oxidizing agent is present, wherein the at least one surfactant can be the same or different from the at least one surfactant in the first part, at least one pH adjusting agent which can be the same or different from the pH adjusting agent(s) in the first part with the pH adjusting agent(s) being present in an amount to provide a pH of at least 10 to the second part, and water. One of the first part or the second part further includes at least one oxidizing agent, and the other part not including the at least one oxidizing agent includes at least one sequestrant. The first part of the composition and the second part of the composition have pH levels which serve to maintain stability of the separate compositions during storage and which when combined for application to a surface to be treated have a lower pH than the second part. Upon combination of the first part of the composition with the second part of the composition the resulting composition automatically is provided with an adjusted pH of 7 to 12. Thus, the cleaning composition is present at a pH which provides for optimum cleaning. Thus, the two part composition allows for adjustment of the pH at the point of use. The two parts in storage are maintained as single phases. Upon combination, whether the composition is a single phase or not does not affect the efficiency of the cleaning. The two parts are preferably combined in admixture in a ratio of about 1:1 but can be admixed in a ratio within a range of from about 3:2 to about 2:3. The two part composition of the invention is particularly useful for providing soap scum and mold/mildew removal on hard surfaces, such as bathroom surfaces. The cleaning composition of the invention is also useful in cleaning soft surfaces, such as carpeting.

Various advantages are provided by the two part cleaning composition of the invention. The composition provides for shelf stability of the cleaning components, most notably the oxidizing agent through the ability to provide one pH level during storage for the part including the oxidizing agent and another pH during treatment of a surface to thereby improve the efficiency of the agent in cleaning in terms of the time required for removal of material from a surface. Halide-containing oxidizing agents are stable at a higher pH, i.e., above 12, but provide for more efficient cleaning at a lower pH, i.e., 7-12, preferably 8-11.5. Peroxygen oxidizing agents are stable at a lower pH, i.e., about 4 to about 5, but provide for more efficient cleaning at a higher pH, i.e., about 7-8.5. A pH below 7 during cleaning is not desired when the oxidizing agent includes a halide since the halide (e.g. chlorine) in the oxidizing agent will decompose to provide an undesirable gas. Other additives, such as sulfamic acid, can be added to scavenge the gas. However, the cleaning efficiency of the oxidizing agent is decreased by the presence of such additive compounds. Accordingly, a preferred pH of the composition upon combination of the two parts of the composition is 7 to 12, more preferably about 8 to about 11.5 and yet more preferably about 8.5 to about 10.5. With a halide-containing oxidizing agent or peroxygen oxidizing agent used on hard surfaces the provision of a pH of about 10 is most preferred to minimize the amount of additives necessary to the part not containing the oxidizing agent in order to overcome the alkalinity of the part containing the oxidizing agent. With a peroxygen oxidizing agent the pH is most preferred about 8 when used on a soft surface, such as carpeting, due to the fact that fibers of the soft surface may have been treated. The lower pH avoids interaction which could damage the treated fibers. These amounts also allow for admixture of the two parts in amounts which are not in a 1:1 ratio blend. Apparatus utilized to store and combine the compositions thus are not required to provide for precise accuracy upon combination of the two parts.

The two part composition of the invention also provides the advantage of using a decreased amount of oxidizing agent. Generally, while an oxidizing agent can be used in an amount above 3% by weight, oxidizing agents preferably are not used in an amount in excess of 3% by weight due to the nature of bleaches. Thus, the composition of the invention preferably includes at least one oxidizing agent in an amount of about 1.5 to about 3% by weight. While the oxidizing agent may be used in an amount below 1.5% by weight, such is less desired since oxidizing agents degrade over time during storage and thus if the initial concentration is too low, older products on the shelf will not be as efficient in cleaning ability over an extended time.

The present invention of a two part composition also allows for maintaining each part as a stable single phase composition during storage to provide for the desired shelf stability as well as also provide at the point of use for a different pH upon admixture. Following admixture, if phase separation occurs, this separation does not decrease the cleaning ability of the composition but in fact with the solvents and surfactants provide for more efficient cleaning, such as of soap scum on hard surfaces.

Further, due to the control of the pH in the different parts upon storage and in use, lower amounts of surfactants, solvents and oxidizing agents can be used which results in a less odorous composition. In particular the solvents and oxidizing agents can be present in a lesser amount which significantly decreases the odor of the composition. Additionally, less harsh effects upon a user's skin from the ingredients will occur. The use of lesser ingredient amounts also necessarily provides for a savings in cost.

The two part composition of the invention can be stored in and dispensed from any conventional container having two compartments which maintain the compositions therein separate during storage but provide for combination upon use. Such combination can occur in a mixing chamber within the container prior to discharge through a common discharge passage, or combination in a common discharge passage, or through intersecting streams exiting separate discharge passages during application to a desired surface. The containers preferably can be trigger or pump dispensing apparatus, squeeze bottles, blister packs, aerosol apparatus or the like. The application of the invention is preferably in the form of a spray.

The method of cleaning a surface with the composition of the invention includes providing for a first composition maintained separately in a first storage container and a second composition maintained separately in a second storage container so that each of the first and second compositions can each be maintained at separate and distinct pH levels which provide stability for the components present therein; and combining the first composition and second composition during, upon or subsequent to discharge of the first composition and the second composition from the first and second storage containers respectively. Upon combination, the pH automatically adjusts to provide a pH which maximizes cleaning efficiency of the oxidizing agent therein.

### BRIEF DESCRIPTION OF DRAWINGS

FIG. 1 illustrates schematically a partially cut-away side view of a two compartment container with a dip tube in each compartment extending to a mixing chamber and thereafter to a common discharge passage and outlet in a spray head.

FIG. 2 illustrates schematically a partially cut-away side view of a two compartment container with a dip tube in each compartment extending to a common discharge passage and outlet in a spray head.

FIG. 3 illustrates schematically a partially cut-away side view of a two compartment container with a dip tube in each compartment extending to separate discharge passages wherein the passages have discharge outlets structured to provide for intersecting spray patterns upon discharge and combination thereby of the compositions contained in the separate compartments in the container.

FIG. 4 illustrates a top view of an intersecting spray pattern possible with the container shown in FIG. 3.

### DETAILED DESCRIPTION OF THE INVENTION

The invention is directed to liquid cleaning compositions which include at least one surfactant, at least one oxidizing agent, at least one sequestrant, at least one pH adjusting agent, water and, optionally, at least one solvent wherein the components are formulated into two parts or compositions so as to allow for maintaining of the two parts separately during storage and for combination in treatment of a desired surface. The provision and storage as two separate parts allows for provision of the two parts as single phase compositions maintained at different pH levels predetermined based on the components present in a respective part to achieve storage or shelf stability. Upon combination of the two parts, the pH levels are automatically adjusted to provide a cleaning composition with a pH which maximizes the cleaning efficiency of the at least one oxidizing agent present. The cleaning composition can be formulated to be suitable for cleaning hard surfaces, such as for removing soap scum and/or mold/mildew stains from surfaces such as kitchen or bathroom surfaces. The two part cleaning composition can also be formulated to provide for cleaning or stain removal on a soft surface, such as carpet.

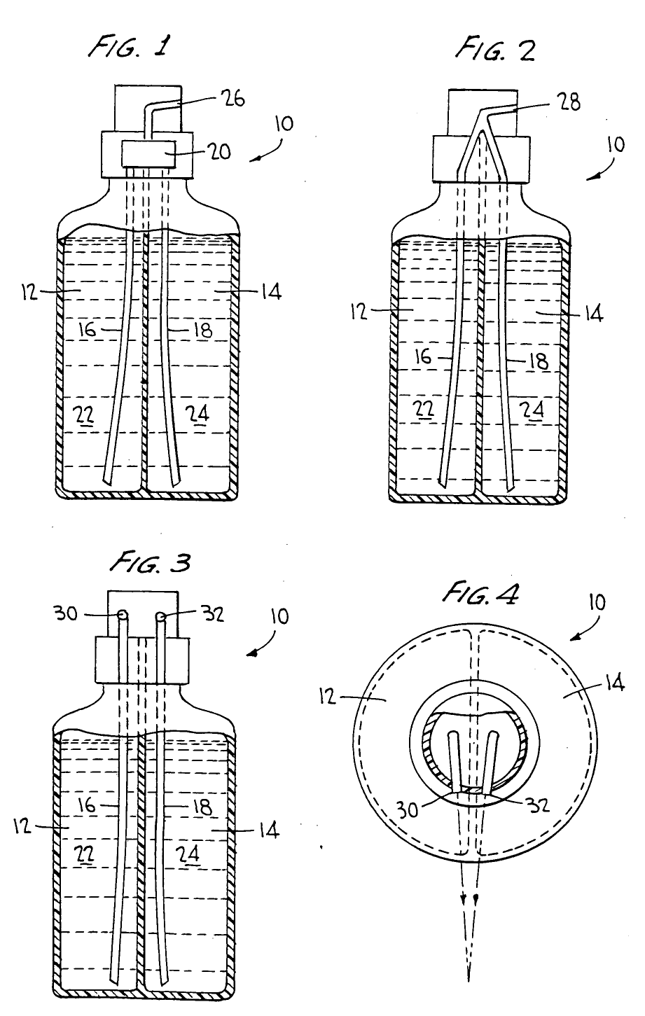

The two part compositions of the invention can be utilized with conventional apparatus which are structured to maintain two liquid compositions separately during storage or non-use and provide for their combination in treatment of a surface. Apparatus suitable for use are known in the art and examples are illustrated schematically in FIGS. 1-4. The embodiments of the FIGURES illustrate different manners in which the two parts can be combined for treatment of a desired surface. A two compartment container holds each part of the two parts separate from each other during storage or non-use which allows for maintaining each part at a different pH level thereby increasing shelf stability of the composition's components. Combination of the two parts can be provided for by various discharge structures. Preferably, mixing of the two parts is provided prior to application of the composition to a surface. However, necessarily, such parts can be combined directly on a surface through manual rubbing or wiping action in the application. More preferably, however, combination of the two parts is provided through the discharge structure of a container, for example as shown in FIGS. 1-4. Combination by an apparatus structure means less work on the part of the user and insures instantaneous commencement of cleaning action by the composition upon application to a surface.

FIG. 1 illustrates a container 10 having a first compartment 12 and a second compartment 14. Each compartment contains a separate dip tube 16 and 18 respectively. Dip tubes 16 and 18 extend to a mixing chamber 20 wherein the separate compositions 22 and 24 contained in the two compartments are combined for discharge through a common discharge passage 26.

FIG. 2 illustrates an alternative embodiment of container 10 having a first compartment 12 and second compartment 14. The separate compartments have separate dip tubes 16 and 18 which, respectively, extend to a common discharge passageway 28 in which the separate compositions are admixed or combined for discharge. Suitable structure as known in the art can be provided in the spray head to prevent back flow.

FIG. 3 illustrates schematically a two compartment container 10 having separate compartments 12 and 14. The compartments contain separate dip tubes 16 and 18, respectively, which extend to separate spray discharge outlets 30 and 32. Discharge outlets 30 and 32 can be structured, such as by suitable angling of the outlets as shown in FIG. 4, to provide for intersection of the different sprays upon discharge and thus combination of the compositions of the two parts subsequent to discharge but prior to application on a surface to be treated.

Accordingly, the two parts of the cleaning composition of the invention can be combined prior to, during or subsequent to discharge in order to provide a composition containing the combined components of the two parts and adjustment of pH in the combined composition.

The two part cleaning composition of the invention includes a first part or first composition which has a pH of from about 4 to about 5, and a second part or second composition having a pH of at least 10. The two parts of the composition are maintained separate during storage and non-use to provide for shelf stability and, thus, efficiency upon combination and use. Upon combination of the first part and the second part to provide the cleaning composition for treatment of a surface, the composition will have an adjusted pH of from 7 to 12, more preferably 8-11.5 and most preferably 8.5-10.5. A pH below 7 is not desirable since in the event the oxidizing agent decomposes, a gas, such as chlorine gas when the oxidizing agent includes a halide, can result which is undesirable. While additives, such as sulfamic acid, can be added to the part of the composition not containing the oxidizing agent in order to scavenge evolved chlorine, such composition will not be as effective in cleaning at lower pHs. The most preferred range of 8.5-10.5 and most preferably about 10 is advantageous as providing for the minimization of the amount of additives to the non-oxidizing agent-containing part which are necessary to overcome the alkalinity of the one part of the composition with the higher pH. Additionally, when the pH is maintained well above 7, a 1:1 blend of the two parts of the composition upon combination or admixture at the point of use is not required. Thus, the apparatus utilized for dispensing can be of a conventional nature and not require high precision.

The two part formulation of the cleaning composition of the invention also allows for the advantage of providing stable single phases for each of the first and second parts while in storage. If the admixture of the first and second parts results in phase separation, such will not affect the efficiency of the cleaning of the admixture since sufficient time for degradation of components to occur will not have been present.

Descriptions of suitable components for use in the composition of the invention are described below.

A first part of the composition includes at least one surfactant when an oxidizing agent is not present in the first part and optionally includes at least one surfactant when an oxidizing agent is present, at least one pH adjusting agent in an amount sufficient to provide a pH to the first part of about 4 to about 5, and water. The second part of the composition includes at least one surfactant when an oxidizing agent is not present in the second part and optionally includes at least one surfactant when an oxidizing agent is present, wherein the at least one surfactant can be the same or different from the at least one surfactant of the first part, at least one pH adjusting agent which may be the same or different from the at least one pH adjusting agent of the first part and is present in an amount sufficient to provide a pH to the second part of at least 10, and water. At least one oxidizing agent is present in the first part or the second part depending on the oxidizing agent selected for inclusion and the pH level desired in view of the selected oxidizing agent. At least one sequestrant will be present in the part of the composition not containing the oxidizing agent(s). Oxidizing agent(s) can degrade sequestrants and thus to enhance stability the sequestrant(s) is/are maintained separate in storage from the oxidizing agent(s). Optionally, at least one solvent can also be present in the composition of the invention. The solvent(s) should preferably be maintained in the part not containing the oxidizing agent(s).

The at least one oxidizing agent preferably is present in an amount from about 1.5 to about 3% by weight. While the oxidizing agent(s) can be present in an amount greater than about 3%, an amount in excess of about 3% is generally undesirable due to the nature of bleaches. Further, an amount below about 1.5% by weight is possible, however, such an amount is generally not advantageous since commercial cleaning solutions desirably have a long shelf life. If an amount below about 1.5% is utilized, the initial concentration may be so low that upon extended shelf or storage time, older products may not be as efficient in cleaning due to degradation of the oxidizing agent over time. The at least one oxidizing agent can be a halogen bleach, such as a hypohalite or hypohalite generating compound, or a peroxygen compound. The oxidizing agent when the composition is utilized as a soap scum and/or mold/mildew stain remover composition or the like preferably is a halogen bleach. Examples of suitable halogen bleaches include alkali metal and alkaline earth salts of hypohalites, haloamines, haloimines, haloimides and haloamides. All of these are believed to produce hypohalous bleaching species in situ. Preferably, the oxidizing agent is a hypohalite or hypohalite generator capable of generating hypohalous bleaching species. The preferred hypohalite oxidizing agent is a hypochlorite or a generator of hypochlorite in aqueous solution. A hypobromite or a hypobromite generator is also suitable for use. The most preferred oxidizing agent is sodium hypochlorite.

When the oxidizing agent is a hypohalite or hypohalite generator, the pH of the part of the composition containing the oxidizing agent is preferably greater than 12.

A peroxygen compound, such as hydrogen peroxide, can also be utilized in the two part cleaning composition of the invention. However, unlike halogen bleaches and hypohalite compounds, peroxygen compounds are stable at low pHs and are required to have the pH increased to optimize the cleaning efficiency thereof. Thus, in the invention when a peroxygen is selected as the oxidizing agent, the peroxygen would be maintained in the part of the composition wherein the pH is maintained from about 4 to about 5. Thus, when this part is combined with the other part, the pH of the composition will be increased to have a pH at a point of use in a range of from 7 to 12, more preferably 7-10 and most preferably 7.5-8.5. When the composition includes a peroxygen compound and is intended to treat a soft surface, such as carpeting, the pH is preferably 7-8.5 and most preferably about 7.5-8. This pH range serves to protect fibers which have been treated in same manner, i.e., avoid adverse interaction between the cleaning composition and the fiber treatment.

Suitable surfactants or co-surfactants which may be utilized in the composition can be selected from a variety of surfactants based upon having moderate to high stability in the presence of the oxidizing agent and for providing the desired functions, e.g. cleaning, stability, etc. The surfactants may be of different types, such as anionic, nonionic, amphoteric, etc. or mixtures thereof. Examples of surfactants suitable for use include alkyl sulfates, alkyl sulfonates, alkyl aryl sulfonates, alkyl phenol ether sulfates, alkyl diphenyl oxide sulfonates, alkyl phosphate esters, amine oxides, betaines, sarcosinates, taurates, etc. and salts thereof. The surfactants selected for use are not critical so long as the surfactant is relatively stable with respect to the oxidizing agent and compatible with other components of the composition to obtain the desired cleaning or bleaching function while exhibiting the desired stability in storage and in use. A preferred surfactant for inclusion in the part containing the oxidizing agent is an amine oxide. Preferred surfactants for inclusion in the non-oxidizing agent-containing part are alkali metal alkyl sulfates and alkali metal alkyl ether sulfates. The surfactant(s) preferably are present in the non-oxidizing agent containing part in an amount of from greater than 0 to about 12% by weight, more preferably from about 0.1 to about 6% by weight. The surfactant(s) preferably are present in the part containing the oxidizing agent in an amount of about 0 to about 5% by weight, more preferably from about 0.1 to about 4% by weight.

Sequestrants are included in the composition of the invention to provide for soap scum efficacy and to act as a buffer to help with pH reduction at the point of use. The sequestrant(s) is/are preferably present in an amount of from about 0 to about 10% by weight, more preferably about 0.1 to about 6% by weight. A preferred sequestrant is citric acid although other conventional sequestrants may be utilized such as carbonates, bicarbonates, phosphates, tartaric acid, gluconic acid, and the like and salts thereof. Other sequestrants such as ethylene diamine tetracetic acid or any other organic nitrogen source, such as triethanolamine, are not preferred for use with hypohalites since such will convert to haloamines which exhibit poor action with regard to mold/mildew stain removal. Citric acid is preferred since it can act to buffer a low pH composition as well as act as a pH adjuster, either alone or in combination with another compound, such as caustic soda.

The pH adjusting agents which are present in each of the two parts of the composition may be the same or different. The pH adjusting agent adjusts the pH of the particular composition to the desired level for that composition. A buffer may be utilized in combination with the pH adjusting agent to assist in maintaining the pH at the desired level. Preferably the pH adjusting agent is a hydroxide, a hydroxide generator or mixture thereof. Additional pH adjusting agents which may be used are alkali metal carbonates, bicarbonates, silicates, phosphates, polyphosphates, pyrophosphates, triphosphates, tetraphosphates, metasilicates, polysilicates, borates, and mixtures thereof. As noted above the pH adjusting agent is used to provide the pH level as desired. In the presence of a hypohalite, the pH is adjusted upward to alkaline, preferably greater than 12. In the presence of a peroxide, the pH of the individual part is adjusted down to an acidic pH, preferably in a range of from about 4 to about 5. Upon admixture of the two parts, the pH adjusting agents provide automatically upon combination the desired pH range for the point of use, which preferably is in a range of 7-12, more preferably about 8-11.5, most preferably about 8.5-10.5. A pH of about 10 is optimum.

The inclusion of a solvent is optional, however, a solvent is preferably present to improve non-streaking and non-filming performance of the cleaning composition and thus obtain optimum cleaning. Various solvents are suitable for use including alcohols, alcohol ethers, glycols, glycol ethers, hydrocarbons, and mixtures thereof. Glycol and glycol ether solvents are preferable as being less volatile, less odorous and compatible with other components. Preferred examples are ethylene glycol ethers and propylene glycol ethers. Suitable hydrocarbons include d-limonene. Solvents may be present singularly or in combination and preferably in an amount of from about 0 to about 10% by weight, more preferably in an amount of from about 0.5-about 5% by weight.

The composition of the invention may also include conventional additives such as fragrances, coloring agents, thickening agents, disinfectants, and the like.

Exemplary embodiments of two part compositions of the invention are set forth below.

### EXAMPLE 1

Example 1 illustrates a two part soap scum and mold/mildew stain removing composition. These compositions are especially suitable for use in cleaning bathroom surfaces. Two examples are set forth which satisfy the non-oxidizing agent-containing part of the composition. Each of these exemplary parts are suitable for use with the oxidizing agent-containing part to provide the combined composition useful at the point of use.

PART 1

| | WT. % | | | |
|---|---|---|---|---|
| INGREDIENTS | A | | B | |
| DEIONIZED WATER | 75.5 | | 71.5 | |
| BUTYL CARBITOL | 6.0 | | C | |
| D-LIMONENE | C | | 4.0 | |
| SODIUM LAURYL SULFATE (30%) | 3.0 | (0.9) | 6.0 | (1.8) |
| SODIUM LAURYL ETHER SULFATE | 3.0 | | 6.0 | |
| PROPYLENE GLYCOL BUTYL ETHER | 5.0 | | 5.0 | |
| PROPYLENE GLYCOL N-PROPYL | 2.5 | | 2.5 | |
| ETHER | | | | |
| CITRIC ACID (50%) | 5.0 | (2.5) | 5.0 | (2.5) |

| | | |
|---|---|---|
| SODIUM HYDROXIDE (50%) | to pH 4.3 | to pH 4.6 |

PART 2

| INGREDIENTS | WT. % | |
|---|---|---|
| SODA ASH | 3.46 | |
| CAUSTIC SODA (50%) | 1.10 | (0.55) |
| SODIUM HYPOCHLORITE (15%) | 21.33 | (3.1995) |
| DECYL DIMETHYL AMINE OXIDE (30%) | 3.33 | (0.999) |
| FRAGRANCE | 0.1 | |
| DEIONIZED WATER | 70.68 | |

Part 2 pH = 12.5

### EXAMPLE 2

Example 2 illustrates a further embodiment of a two part soap scum and mold/mildew stain removing composition. Two examples of a non-oxidizing agent-containing part of the composition are set forth. Each of these parts are suitable for use with the oxidizing agent-containing part set forth.

PART 1

| | WT. % | | | |
|---|---|---|---|---|
| INGREDIENTS | A | | B | |
| DEIONIZED WATER | 67.3 | | 82.2 | |
| DIETHYLENE GLYCOL BUTYL | 6.0 | | 3.0 | |
| ETHER | | | | |
| SODIUM LAURYL SULFATE | 3.0 | (0.9) | 3.0 | (0.9) |
| (30%) | | | | |
| SODIUM LAURYL ETHER | 3.0 | | 3.0 | |
| SULFATE | | | | |
| DIPROPYLENE GLYCOL | 5.0 | | 2.25 | |
| MONOBUTYL ETHER | | | | |
| DIPROPYLENE GLYCOL | 2.5 | | 1.25 | |
| N-PROPYL ETHER | | | | |
| CITRIC ACID (50%) | 10.0 | (5.0) | 4.0 | (2.0) |
| FRAGRANCE | 0.2 | | 0.2 | |
| SODIUM HYDROXIDE (50%) | 3.0 | (1.5) | 1.1 | (0.55) |
| | 100% | | 100% | |

Part 1 pH = 4-5

PART 2

| INGREDIENTS | WT. % | |
|---|---|---|
| SODA ASH | 3.46 | |
| CAUSTIC SODA (50%) | 1.10 | (0.55) |
| SODIUM HYPOCHLORITE (15%) | 21.33 | (3.1995) |
| DECYL DIMETHYL AMINE OXIDE (30%) | 3.33 | (0.999) |
| FRAGRANCE | 0.1 | |
| DEIONIZED WATER | 70.68 | |
| | 100% | |

Part 2 pH = >12

### EXAMPLE 3

Example 3 illustrates a two part carpet cleaning formulation including hydrogen peroxide as the oxidizing agent.

| | WT. % | | |
|---|---|---|---|
| INGREDIENTS | Combination | Part 1 | Part 2 |
| DEIONIZED WATER | 84.325 | 94.8 | 73.85 |
| SODIUM CARBONATE, | 0.625 | 1.25 | — |
| ANHYDROUS | | | |
| SODIUM BICARBONATE, | 0.375 | 0.75 | — |
| COARSE GRANULAR | | | |
| TETRA SODIUM 1-HYDROXY | 0.25 | 0.5 | — |
| ETHYLIDENE-1,1- | | | |
| DIPHOSPHONIC | | | |
| ACID (100%) | | | |
| ZELAN 338 Carboxylated | 0.5 | 1 | — |
| Polymer Salt (DuPont) | | | |
| PERFUME | 0.15 | 0.3 | — |
| C₁₂₋₁₄ Secondary | 0.2 | 0.4 | — |
| Ethoxylated Alcohol | | | |
| (>97%) | | | |
| SODIUM LAUROYL | 0.5 (0.15) | 1 (0.3) | — |
| SARCOSINATE (30%) | | | |
| SODIUM CITRATE USP, | 0.075 | — | 0.15 |
| granular, dihydrate | | | |
| CITRIC ACID, USP, | 0.05 | — | 0.1 |
| Anhydrous | | | |
| SODIUM LAURYL | 3 (0.9) | — | 6 (1.8) |
| SULFATE (30%) | | | |
| ETHYLENE GLYCOL | 0.8 | — | 1.6 |
| N-HEXYL ETHER | | | |
| PLURAFAC SL-22[C₆₋₁₀ | 0.15 | — | 0.3 |
| ethoxylated propoxylated | | | |
| alcohols (48-58.5% | | | |
| monooctyl ether 30-50% | | | |
| monodecyl ether)] | | | |
| HYDROGEN PEROXIDE (35%) | 9 (3.15) | — | 18 (6.3) |
| Cosmetic Grade | | | |

As will be apparent to one skilled in the art, various modifications can be made within the scope of the aforesaid description. Such modifications being within the ability of one skilled in the art form a part of the present invention and are embraced by the appended claims.

1. A cleaning composition comprising
(a) a first part comprising at least one pH adjusting agent and at least one surfactant when an oxidizing agent is not present in the first part and optionally includes at least one surfactant when an oxidizing agent is present in the first part, wherein said first part has a pH in a range of from about 4 to about 5;
(b) a second part comprising at least one pH adjusting agent which can be same or different from the at least one pH adjusting agent of the first part, and at least one surfactant when an oxidizing agent is not present in the second part and optionally at least one surfactant when an oxidizing agent is present in the second part, wherein the at least one surfactant can be same or different from the at least one surfactant of the first part, wherein said second part has a pH in a range of 10 or greater;
wherein one of said first part or said second part further comprises at least one oxidizing agent and one of said first part or said second part not containing said at least one oxidizing agent contains at least one sequestrant; and wherein upon combination of said first part with said second part to provide a combined composition, said combined composition has a pH in a range of from 7 to 12.

2. The cleaning composition according to claim 1 wherein said at least one oxidizing agent is a halide-containing compound and is present in said second part, wherein the pH of said second part is greater than 12, and wherein said at least one sequestrant is present in said first part.

3. The cleaning composition according to claim 1, wherein said at least one oxidizing agent is a peroxide compound and is present in said first part, and wherein said at least one sequestrant is present in said second part.

4. The cleaning composition according to claim 2, wherein at least one solvent is present in said first part.

5. The cleaning composition according to claim 3, wherein at least one solvent is present in said second part.

6. A cleaning composition comprising
(a) a first part comprising at least one surfactant, at least one sequestrant, at least one pH adjusting agent present in an amount to provide a pH of from about 4 to about 5 in the first part, water and, optionally, at least one solvent; and
(b) a second part comprising at least one oxidizing agent, at least one pH adjusting agent which is same or different from the at least one pH adjusting agent of the first part and present in an amount to provide a pH of above 12 in the second part, water, and optionally at least one surfactant which is same or different from said at least one surfactant of the first part;
wherein said first part and said second part are maintained separate from each other during storage, and upon combination of said first part and said second part provide a combined composition having a pH in a range of from 7 to 12.

7. A cleaning composition according to claim 1 or 6, wherein said first part and said second part are present in said combined composition in a ratio of about 1:1.

8. A cleaning composition according to claim 1 or 6, wherein said first part and said second part are present in said combined composition in a ratio in a range of about 3:2 to about 2:3.

9. The cleaning composition according to claim 1 or 6, wherein said at least one surfactant of said first part and/or said second part is anionic, nonionic, amphoteric or a mixture thereof.

10. The cleaning composition according to claim 9 wherein said at least one surfactant is selected from a group consisting of alkyl sulfates, alkyl sulfonates, alkyl aryl sulfonates, alkyl phenol ether sulfates, alkyl diphenyl oxide sulfonates, alkyl phosphate esters, amine oxides; betaines, sarcosinates, taurates, and salts thereof.

11. The cleaning composition according to claim 1 or 6, wherein said at least one sequestrant is selected from a group consisting of citric acid, carbonates, bicarbonates, phosphates, tartaric acid, gluconic acid, and salts thereof.

12. The cleaning composition according to claim 1 or 6, wherein said at least one pH adjusting agent of said first part and/or said second part is selected from a group consisting of citric acid, hydroxides, a hydroxide-generating compounds, carbonates, bicarbonates, silicates, phosphates, polyphosphates, pyrophosphates, triphosphates, tetraphosphates, metasilicates, polysilicates, borates, and mixtures thereof.

13. The cleaning composition according to claim 4 or 6, wherein said at least one solvent is selected from a group consisting of alcohols, alcohol ethers, glycols, glycol ethers, hydrocarbons, and mixtures thereof.

14. The cleaning composition according to claim 2 or 6, wherein said at least one oxidizing agent is a halogen bleach.

15. The cleaning composition of claim 14, wherein the halogen bleach is a hypohalite or hypohalite-generating compound.

16. The cleaning composition according to claim 3, wherein said at least one oxidizing agent is a peroxygen compound.

17. The cleaning composition according to claim 16, wherein the peroxygen compound is hydrogen peroxide.

18. The cleaning composition according to claim 2 or 6, wherein said at least one surfactant of said second part is an amine oxide surfactant.

19. The cleaning composition according to claim 6 wherein said at least one surfactant of said first part is present in an amount greater than 0 to about 12% by weight; said solvent of said first part is present in an amount of from 0 to about 10% by weight; said at least one sequestrant is present in an amount from about 2 to about 10% by weight; said at least one oxidizing agent is present in an amount of from about 1.5 to about 3% by weight; said at least one surfactant of said second part is present in an amount of from about 0 to about 5% by weight.

20. A cleaning composition comprising (a) a first part comprising from about 3 to about 6% by weight of sodium lauryl sulfate; from about 3 to about 6% by weight sodium lauryl ether sulfate; about greater than 0 to about 5% by weight of propylene glycol butyl ether; greater than 0 to about 5% by weight of propylene glycol N-propyl ether; about greater than 0 to about 10% by weight of citric acid; sodium hydroxide in an effective amount to provide a pH of about 4.3-4.6; and a solvent in an amount from 0 to about 6% by weight, said solvent when present being butyl carbitol and/or d-limonene; and a balance of water; and
(b) a second part comprising sodium hypochlorite in an amount of about 1.5% to about 3.0% by weight; about 3 to about 6% by weight of an amine oxide surfactant; sodium hydroxide and alkali metal carbonate in effective amounts to provide a pH in said second part of greater than 12; and a balance of water; and
wherein upon combination of said first part and said second part, a combined composition is provided having a pH from about 9 to about 11.

21. An apparatus for cleaning a surface comprising
(a) a first compartment for containing a first composition comprising said first part of claim 1;
(b) a second compartment for containing a second composition comprising said second part of claim 1; and
(c) discharge means for discharging said first composition and said second composition;
wherein one of said first composition or said second composition further comprises at least one oxidizing agent and one of said first composition and said second composition not containing said at least one oxidizing agent contains at least one sequestrant; and
wherein said first composition and said second composition are maintained separate from each other in storage and upon combination of said first composition and said second composition during, upon or subsequent to said discharging, said discharge means provides a third composition having a pH in a range from 7 to 12.

22. An apparatus for cleaning a surface comprising
(a) a first compartment for containing a first composition comprising a first part according to claim 6;
(b) a second compartment for containing a second composition comprising a second part according to claim 6; and
(c) discharge means for discharging said first composition and said second composition;
wherein said first composition and said second composition are maintained separate from each other in storage and upon combination of said first composition and said second composition during, upon or subsequent to said discharging, said discharge means provides a third composition having a pH in a range from 7 to 12.

23. A method of cleaning a surface comprising combining a first composition maintained in a first storage container at a pH of from about 4 to about 5 with a second composition maintained in a second storage container at a pH of greater than 10, during, upon or subsequent to discharge of said first composition and said second composition from said first storage container and said second storage container, respectively; wherein
(a) said first composition comprises a first part according to claim 1, and
(b) said second composition comprises a second part according to claim 1,
wherein one of said first composition or said second composition further comprises at least one oxidizing agent, and one of said first composition or said second composition not containing said at least one oxidizing agent contains at least one sequestrant, and wherein upon said combining of said first composition and said second composition, a combined composition is formed having a pH in a range of from 7 to 12.
